(19) United States
(12) Patent Application Publication
(10) Pub. No.: US 2002/0122078 A1
(43) Pub. Date: Sep. 5, 2002

(54) System and method for organizing, navigating and analyzing data

(76) Inventor: Michael J. Markowski, Tallahassee, FL (US)

Correspondence Address: WOLF GREENFIELD & SACKS, PC, FEDERAL RESERVE PLAZA, 600 ATLANTIC AVENUE, BOSTON, MA, 02210-2211, US

(21) Appl. No.: 10/011,050

(22) Filed: Dec. 7, 2001

Related U.S. Application Data
(60) Provisional application No. 60/254,170, filed on Dec. 7, 2000.

(51) Int. Cl. G09G 5/00

(52) U.S. Cl. 345/853

(57) ABSTRACT

An information resource (IR) and method, and a graphical user interface for accessing data from the information resource. The IR is a collection of data (typically data relating to an entity, such as various securities and company performance data), stored at one or more Web sites or linked. A graphical user interface (GUI) presents to a user a hierarchical arrangement of the data (e.g., company and/or security performance) and analytical tools for their evaluation. The levels of the hierarchy correspond to absolute or comparative degrees of performance. In an embodiment, a Web site is provided having a page which, when addressed by a client browser, provides or serves up a GUI; and in the GUI, parameters to be evaluated are arranged along a first vector and for each said parameter, a plurality of selectable analytical tools are arranged along a second vector.

Priority is claimed under 35 USC 119(e) from provisional application serial no. 60/254,170, filed on Dec. 7, 2000.

### FIELD OF THE INVENTION

This invention relates to the field of organizing data and data-related analytical tools to facilitate navigation through the data, and efficient use of the tools to analyze those portions of the data in which a user is interested. In one contemplated application, the data relates to the financial performance of public companies and their securities, and the tools are calculators of various measures of performance (of a company and/or a security) for various periods of time. The data may be accessed from remote locations via access to one or more Internet web sites, for example. A network arrangement for organizing the data is shown along with a graphical user interface for selecting and navigating through tools for analyzing the data.

### BACKGROUND OF THE INVENTION

The rigorous analysis of financial and securities performance for approximately 15,000 domestic U.S. and another 65,000 international public companies is a daunting challenge. Investors experience many obstacles when analyzing and comparing securities, making buy/sell/hold decisions and otherwise managing their investment portfolios. For example, the information may be distributed among several unrelated publications, web sites or other sources. The analytical tools are not interrelated at all or, if somewhat interrelated, are not related in a logical, useful way. The investor is thus left to his or her best, unguided effort to locate and then make sense out of a lot of complex and confusing information. In lieu of attempting their own analyses or incurring the considerable amount of time required to find both performance data and analysis engines, many investors thus turn to professional money managers or mutual funds and abdicate investment analysis and management to others. In turn, the professional money managers and mutual fund managers often depend on the knowledge and insight of analysts who restrict their market view to niches (sectors) in which they can get to know the main companies involved so as to be able to distinguish their performance (one from the other).

Professional and non-professional investors and analysts all seek to use knowledge of historical performance of a particular security, together with macro-economic data, company reports and news releases and market sector projections, to gain insight into the security's likely performance going forward.

Consequently, needs exist for new and efficient ways for investors, investment advisers and others to access relevant data on one or more companies and their traded securities. Needs also exist for new and efficient ways for such parties to select or be guided to useful analytical tools, and for such parties to view a particular company's security relative to others.

### SUMMARY OF THE INVENTION

These and related needs are addressed by providing to users an information resource and a graphical user interface for accessing the information provided by the information resource. The graphical user interface may, for example, be accessed locally or remotely, such as via a network, preferably using a client-server architecture. The client and server computers may be one or more sites on a network such as the World Wide Web portion of the global Internet.

According to a first aspect of the invention, an information resource is provided which is a collection of various securities and company performance data as well as links to sources of that data. This data may be stored at one or more Web sites or elsewhere.

According to another aspect of the invention, a graphical user interface (GUI) is provided which presents to a user a hierarchical arrangement of at least one of company performance and security performance, and analytical tools for their evaluation. The user interface provides a graphical view of analytical tools arranged in a hierarchical fashion. The levels of the hierarchy correspond to absolute or comparative degrees of performance.

Optionally, an analytical tool may be selected via the interface for presenting an analysis of data in one of a number of predetermined, defined contexts which may, for example, include historical context.

The graphical user interface may provide access to tools which analyzes a company or security relative to others in its industry sector. The GUI also may provide access to one or more tools which analyze a company or security relative to one or more appropriate indices.

The interface may be provided at a Web site.

According to another aspect, the invention comprises a method of facilitating the presentation of data regarding the performance of a company and a security issued by the company, comprising providing a Web site having a page which, when addressed, provides a graphical user interface; and in the graphical user interface, arranging along a first vector a plurality of parameters to be evaluated and for each said parameter, arranging along a second vector a plurality of selectable analytical tools.

The method may include the analytical tools arranged along said second vector being arranged in like order for each of the parameters.

The method also may include receiving a user's selection of a company name or security symbol just once, while allowing a user to navigate among said analytical tools without re-entering that information.

Further, the tools may be selectable by a user moving a cursor onto a cell or segment representing a tool and then signaling selection of the tool as, for example, by clicking a mouse button.

According to yet another aspect, the invention involves a method of facilitating the presentation of data regarding the performance of a company and a security issued by the company. A data source is provided, containing quantitative information about the current and historical performance of the security. Also provided is a network of web sites, each having a page which, when addressed, provides a graphical user interface for invoking a predetermined tool for analyzing the security according to that tool. On the web sites, pointers are displayed to selected other ones of the web sites such that the pointers have the effect of arranging the web sites along a first selection vector related to a plurality of parameters to be evaluated and further arranging the web sites such that for each said parameter pointers organize the sites along a second selection vector along which are arrayed a plurality of selectable analytical tools. Preferably, the analytical tools are arranged along said second vector in like order for each of the parameters. The method may allow a user's selection of a company name or security symbol just once while allowing a user to select desired ones of said pointers to navigate among said analytical tools. Preferably each pointer corresponds to a tool and tools are selectable by a user moving a cursor onto a cell representing a tool itself or a pointer to the tool and then signaling selection of the tool.

According to yet another aspect, there is provided a graphical user interface which presents to a user a hierarchical arrangement of domain-specific performance data, and analytical tools for their evaluation. An analytical tool may be selected for presenting an analysis of data in one of a number of predetermined, defined contexts. The defined context may, for example, be historical. Preferably, but not necessarily, the graphical user interface may be provided as a page or pages served up by an appropriately programmed server computer at a web site.

Still another aspect is a method of facilitating the presentation of data relating to the performance of an entity, comprising providing a web site having a page which, when addressed, provides a graphical user interface; in the graphical user interface, arranging along a first vector a plurality of parameters to be evaluated relative to said entity data; and for each said parameter, arranging along a second vector a plurality of selectable analytical tools for evaluating the data. Optionally, the analytical tools may be arranged along said second vector in like order for each of the parameters. Preferably, a user's selection of an entity identity need be entered just once while allowing a user to navigate among said analytical tools. The tools may be selectable by a user moving a cursor onto a cell representing a tool and then signaling selection of the tool as, for example, by clicking a mouse button. The entity may be a sports team, among other possibilities.

According to a still further aspect, the invention provides a method of facilitating the presentation of data regarding the performance of an entity, comprising: providing a data source of quantitative information about the current and historical performance of the entity; providing a network of web sites, each having a page which, when addressed, provides a graphical user interface for invoking a predetermined tool for analyzing the entity according to that tool; and providing on the web sites pointers to selected other ones of the web sites such that the pointers have the effect of arranging the web sites along a first selection vector related to a plurality of parameters to be evaluated and further arranging the web sites such that for each said parameter pointers organize the sites along a second selection vector along which are arrayed a plurality of selectable analytical tools. The analytical tools may be arranged along said second vector in like order for each of the parameters. Preferably, a user's selection of an entity identification need be received just once while allowing a user to select desired ones of said pointers to navigate among said analytical tools. Each pointer may correspond to a tool and tools may be selectable by a user moving a cursor onto a cell representing a tool itself or a pointer to the tool and then signaling selection of the tool.

Yet another aspect of the invention is a graphical user interface which presents to a user a hierarchical arrangement of past performance of an entity and analytical tools for studying the entity's performance from a plurality of perspectives.

Still a further aspect is a method of facilitating the presentation of data regarding the performance of an entity, comprising: providing a data source of quantitative information about the current and historical performance of the entity; providing a network of web sites, each having a page which, when addressed, provides a graphical user interface for invoking a predetermined tool for analyzing the entity according to that tool; and providing on the web sites pointers to selected other ones of the web sites such that the pointers have the effect of arranging the web sites along a first selection vector related to a plurality of parameters to be evaluated and further arranging the web sites such that for each said parameter pointers organize the sites along a second selection vector along which are arrayed a plurality of selectable analytical tools. The analytical tools may be arranged along said second vector in like order for each of the parameters. Preferably each pointer corresponds to a tool and tools are selectable by a user moving a cursor onto a cell representing a tool itself or a pointer to the tool and then signaling selection of the tool.

Another aspect of the invention is a computer program product comprising a computer-readable medium having encoded therein instructions which when executed by a computer system provides a graphical user interface which presents to a user a hierarchical arrangement of at least one of company performance and security performance, and analytical tools for their evaluation. An analytical tool may be selected for presenting an analysis of data in one of a number of predetermined, defined contexts.

A further aspect is a computer program product comprising a computer-readable medium having encoded therein instructions which when executed by a computer system provides a web site having a page which, when addressed, provides a graphical user interface in which there are arranged along a first vector a plurality of parameters to be evaluated and for each said parameter, there are arranged along a second vector a plurality of selectable analytical tools. The analytical tools arranged along said second vector may be arranged in like order for each of the parameters. The parameters may relate to a company or its security and the instructions may allow a user's selection of a company name or security symbol to be input just once while allowing a user to navigate among said analytical tools.

Yet another aspect is a computer program product comprising a computer-readable medium having encoded therein instructions which when executed by a computer system provides a network of web sites, each having a page which, when addressed, provides a graphical user interface for invoking a predetermined tool for analyzing a security according to that tool; and on the web sites, pointers to selected other ones of the web sites, such that the pointers have the effect of arranging the web sites along a first selection vector related to a plurality of parameters to be evaluated and further arranging the web sites such that for each said parameter pointers organize the sites along a second selection vector along which are arrayed a plurality of selectable analytical tools. The analytical tools arranged along said second vector may be arranged in like order for each of the parameters.

### BRIEF DESCRIPTION OF THE DRAWINGS

The foregoing and other features and advantages of the present invention will become more fully understood and appreciated from the detailed description below, which should be read in conjunction with the accompanying drawings, wherein like numerals refer to like elements.

In the drawings:

FIG. 1 is a diagrammatic illustration of a system in which the invention may be provided;

FIGS. 2A and 2B are diagrammatic illustrations of graphical user interface devices according to an embodiment of the invention, as might be viewed on a client (browser) computer screen;

FIGS. 3A-3E are diagrammatic illustrations of alternative graphical user interface device schema for hierarchically arranging relationships between parameters being analyzed and tools used for the analysis, as taught herein; and

FIG. 4 is a diagrammatic illustration of an alternative flat matrix graphical user interface presentation in accordance with these teachings.

### DETAILED DESCRIPTION

Broadly speaking, an information resource as taught herein may comprise a web site or a collection of web sites and a graphical user interface is provided for accessing and viewing the data collected by or in the information resource.

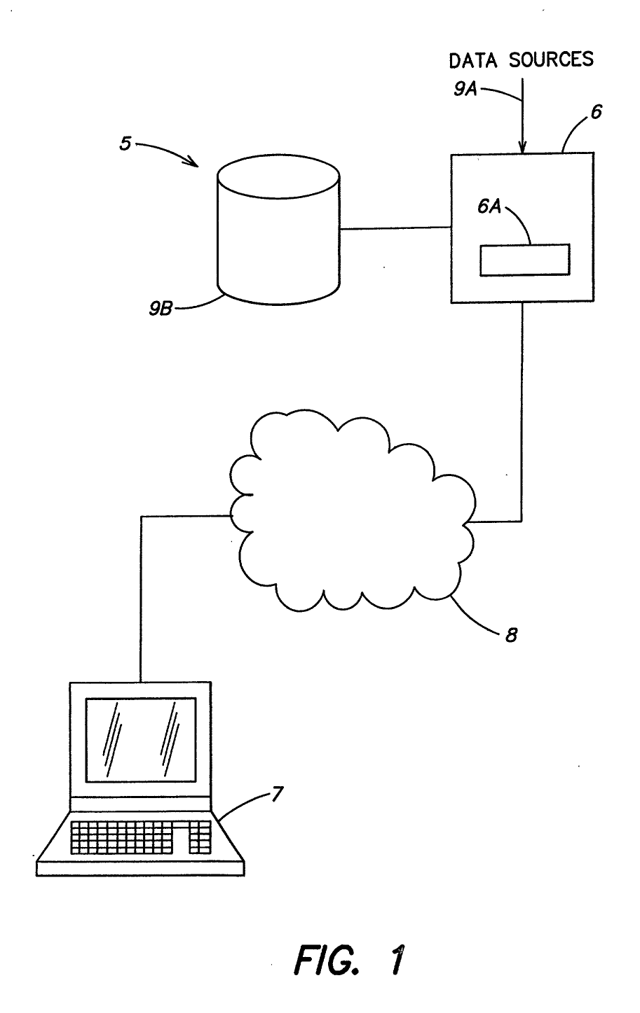

Starting at FIG. 1, there is shown an exemplary computer network 5 on which the present invention may be implemented. The computer network 5 comprises at least one server computer 6, at least one client computer 7 and a communication channel 8 through which the client and server computers interact. Channel 8 may be any suitable network, including the global Internet. Server computer 6 may receive data from one or more data sources 9A and may store data internally or externally in a database 9B. Computer programs (software) for execution by server computer 6 may be stored therein or supplied thereto on or by any medium 6A (e.g., read-only memory, random access memory, or magnetic or optical storage).

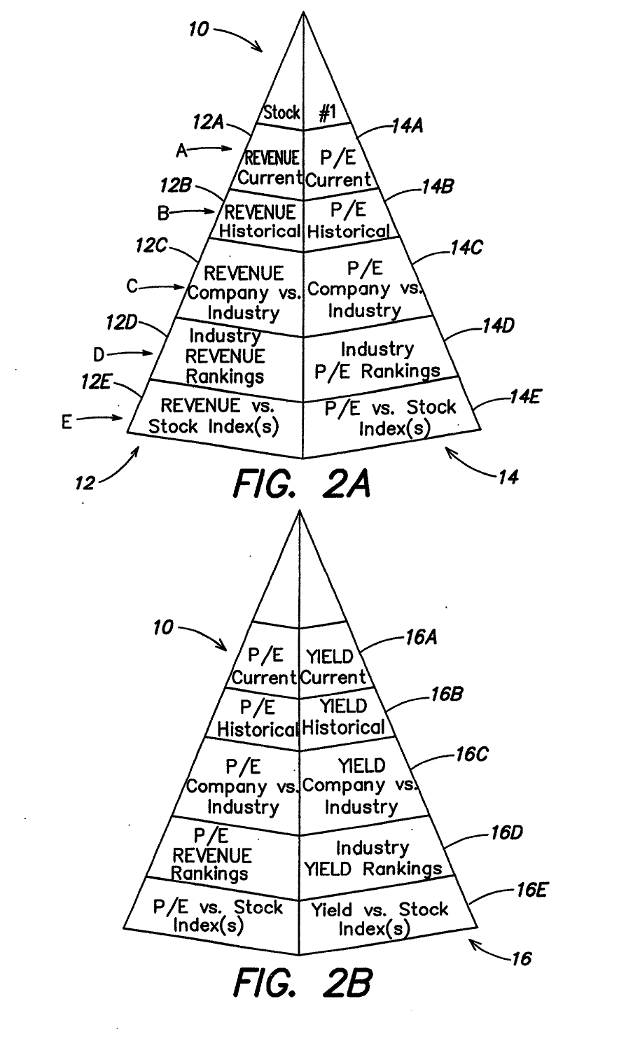

Turning to FIG. 2A, there is shown a representation 10 of an exemplary graphical user 5 interface (GUI) according to the invention, for display on a computer screen, to evaluate or analyze a selected security. The GUI typically may be provided as a page or pages served up from a server, 6, to a display at a client, 7, at which a user may interact with it (the GUI, that is). As will become apparent from the discussion which follows, the GUI may represent and be used as not only a mode of accessing data in the information resource, but also it may mirror to the user a network of Web sites comprising the information resource itself. That is, the data in the information resource may (but of course, need not) be organized in a way that parallels the views and interrelationships shown in the GUI.

As a first example, the GUI representation 10 may take the form of a three-sided pyramid (two sides of which are visible in each of FIGS. 2A-2B) which is hierarchically arranged into a series of layers. Each layer is divided into segments, one per side of the pyramid. For purposes of illustration, the security may be considered a common stock, though it could be any type of publicly traded security. Along one side 12 of the pyramid, the information at each layer (accessed when the user points a cursor at the corresponding segment of the layer and clicks on a selection device such as a mouse or keyboard) deals with a different look at a single characteristic parameter of the issuing company's financial performance; in FIG. 2A, that parameter is its revenue. At layer A, segment 12A, the current revenue for the company may be viewed. At layer B, segment 12B, historical revenue information is available. (For example, revenue by quarter for five years.) At layer C, segment 12C, the information available is a comparison of the company's revenue, current and historical, with the relevant industry sector. At segment 12D in layer D, the ranking of the company in its industry sector, by revenue, is given. Finally, the company's revenue is shown (graphed) at segment 12E in layer E against a number of stock indices.

Along the second side 14 of the pyramid, each of the layers provides an analysis or evaluation of some aspect of the price-to-earnings ratio (P/E) for the stock. Segment 14A provides the current P/E. At segment 14B, historical P/E information is available. (For example, P/E by quarter for five years.) At segment 14C, the information available is a comparison of the stock's P/E, current and historical, with the relevant industry sector. At segment 14D, the ranking of the stock in its industry sector, by P/E, is given. Finally, at segment 14E, the stock's P/E is shown (graphed) against a number of stock indices.

FIG. 2B shows the pyramid 10 from another view, rotated to show the third side, 16. On side 16, all of the layers are devoted to information based on the yield of the stock (i.e., earnings per share). Segment 16A gives the current yield. At segment 16B, historical yield information is available. (For example, yield by quarter for five years.) At segment 16C, the information available is a comparison of the company's stock yield, current and historical, with the relevant industry sector. At segment 16D, the ranking of the company stock in its industry sector, by yield, is given. Finally, the company's stock yield is shown (graphed) against a number of stock indices.

Of course, the pyramid may have more than three sides. Additional sides may be added, each devoted to a different stock or company financial performance parameter, with layers arrayed in like fashion to facilitate navigation and understanding. Each layer, regardless of the number of sides, is devoted to the same type of analysis, albeit on a different parameter. (If an analysis is irrelevant or makes no sense with respect to a parameter, of course the corresponding layer may be inactive.) A side may be added, for example, for profit (also called earnings), or for sales bookings (which may be contrasted with revenue, as not yet received).

The user may enter the stock name or stock symbol in an entry box, not shown. Thereafter, the user may navigate the pyramid using a mouse or keyboard input keys. On a keyboard, the “up” and “down” arrows or “page up” (PgUp) and “page down” (PgDn) keys can be used to navigate up and down a given side of the pyramid; to change sides of the pyramid, the “left” and “right” arrows may be used.

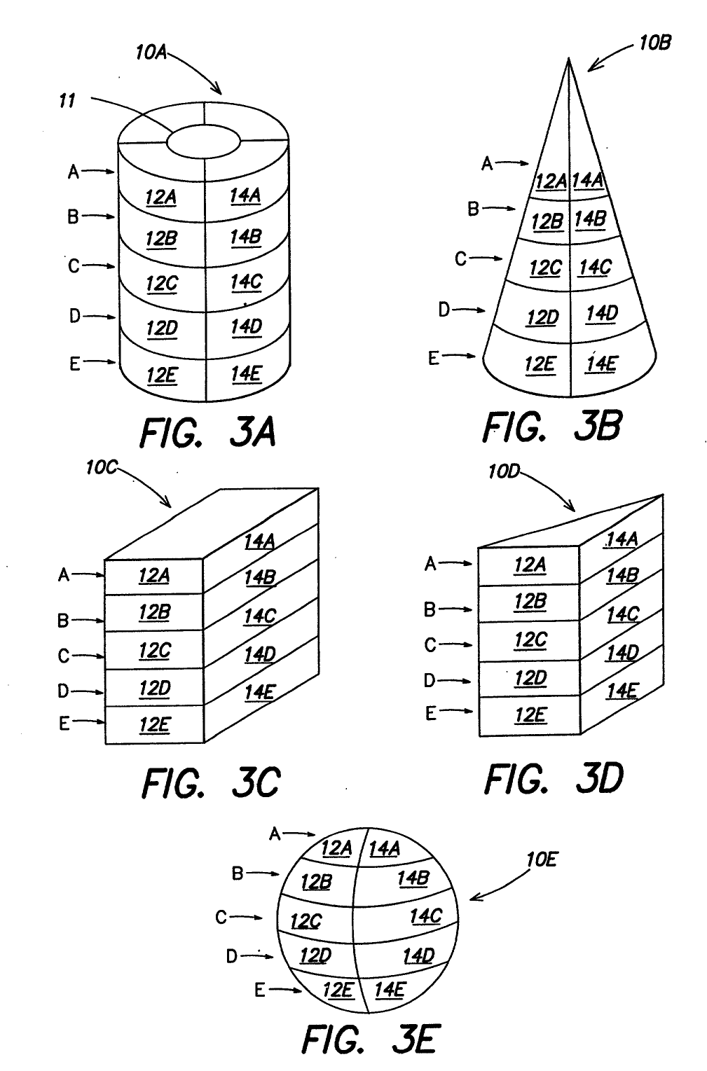

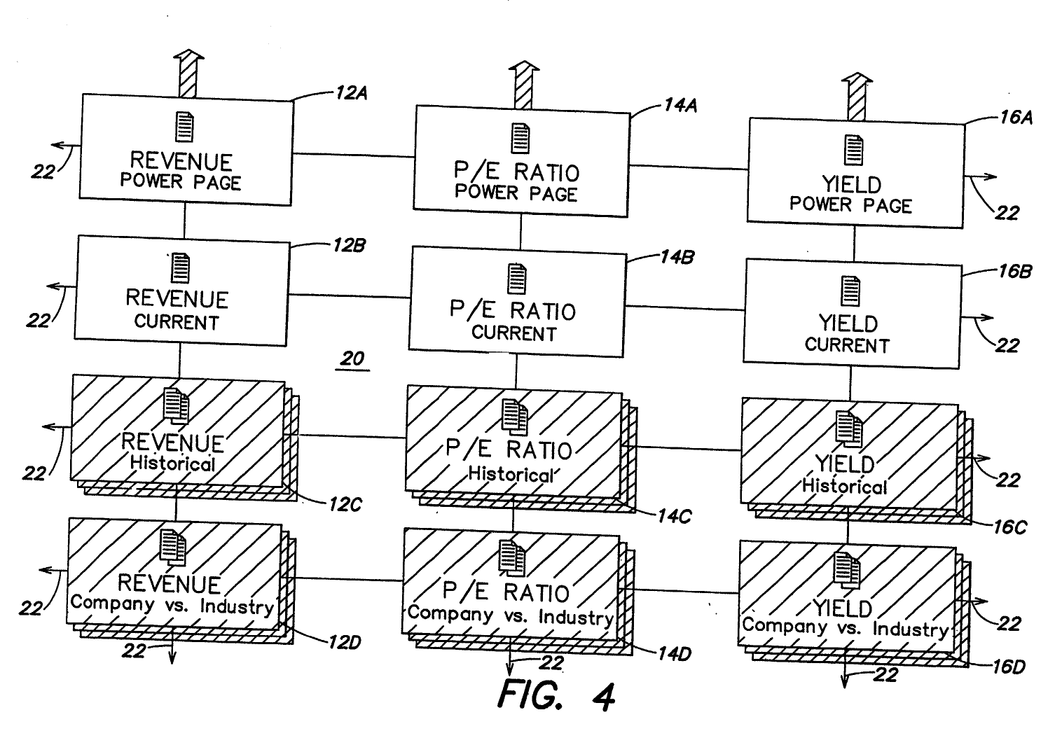

As illustrated in FIGS. 3A-3E, while the pyramid 10 is a useful way to visualize the relationships between the parameters analyzed and the tools used, a cylinder 10A (solid or with a core 11 removed), cone 10B, rectangular solid 10C, prism 10D, sphere 10E or other suitable (typically three-dimensional) arrangement also may be employed, as an alternative. The interface is a way of organizing relevant parameters relating to a security or company financial performance over time, as analyzed by various tools (e.g., historical plots, comparison to others in the same industry, etc.). In general, the interface is a way of visualizing a matrix or network (hereafter, “matrix) of such analyses. Turning to FIG. 4, a flat presentation of the matrix is given. Each box represents a segment at a particular “side” and layer (i.e., segment or face), depicted in the graphical object 10. To indicate that the number of layers and sides of the pyramid may be extended, arrows 22 extend from the boxes at the edges of the matrix 20.

For generality, the different analyses of, or tools for analyzing, a specific parameter, shown in a column of the matrix, are thought of as arrayed as a vector along a first dimension. The different parameters, by contrast, shown in a row of the matrix, may be thought of as arrayed along a second dimension. The dimensions intersect at the boxes in the matrix or the segments (generically, “cells”) at each level of the GUI.

Preferably, all historical views are presented in tables and on graphs that employ a common format and interval, to simplify comparisons. That is, the data is preferably normalized in its presentation.

Thus, by going to a single web site (e.g., directing a browser client to a specified web site address, or URL, served up by a corresponding server computer) that provides the described user interface, a user at the client computer can obtain a full range of analyses of a company and its stock, and compare their performance to others. Preferably, the stock symbol or company name need be entered only once to generate and access all of the presentations. The analyses can all be done upon entry of the stock symbol or company name, or upon demand when the user clicks on a particular box in the matrix or layer and side in the pyramid. Rather than having to go to a large number of web sites, each of which has its own way of presenting its information, and each requiring re-entry of stock symbol or company name, the user is given a much simplified, unified interface for evaluating securities.

The data, the graphical interface and the various analytical tools may be deployed in a variety of ways., including at one web site or at multiple web sites, maintained on one server or multiple servers. The tools themselves can just as well be deployed at different web sites as at one web site, preferably linked to at least one site containing the full view of the interface. For example, each collection of tools along a side (first axis) of the interface (or column of the matrix) may be deployed at a same web site, which may be limited to that content, so that the tools are deployed over an assembly of web sites corresponding to the number of parameters to be analyzed. When a user elects to traverse from one web site to another, to analyze a different parameter at a same level as the previously selected analysis tool, the company name of stock symbol or other identification criteria is passed to the newly chosen site, to call up appropriate data. Or one web site may be provided for each “cell” in the matrix. (With such an arrangement, a user may, instead of accessing the tools via the graphical user interface, also access the tools by addressing directly the appropriate web site.) Whether one site or several are employed, the interface is multi-dimensional. It leads users down an axis, or vector, and allows them to transition easily to the same level on another like axis, or vector, so that the users can do comparisons and gain insights as to how one tool and one metric relates to another tool and another metric at that level. It also enables users to transfer to another vector in a different direction, to allow them to compare a different security at the same level. For example, General Motors' ten-year revenues can be compared against its ten-year P/E or then-year yield. Similarly, the ten year high/low revenues, P/E or yields for General Motors, IBM and AOL can be compared.

The same interface may be duplicated on each or at least on appropriate pages of the site or sites used to access the analytical tools, to facilitate navigation from page to page without forcing the user to back up to a different page before changing tool views. Or some pages (e.g., those on which available space is limited) may be provided with a small shortcut icon to point to and access another page containing a sufficiently large rendering of the interface as to be useful. This page may pop up as a window overlaying the calling page, if desired.

Optionally, predefined sequences of analyses may be provided, specific to different stocks or styles of investing. These show a user a logical progression through a set of tools to make a certain type of informed decision.

The data to be displayed and/or analyzed may be retrieved from any of a variety of sources 9A, such as a company's web site, SEC filings, stock exchange databases, commercial electronic data feeds and publications.

The inventive techniques have been illustrated in the context of the data being securities data. However, these techniques are equally applicable to other sets of complex, multi-parametered data or data which may be analyzed from a number of different perspectives with the use of a number of different analytical tools. For example, looking at how a stock performed under certain market conditions in the past is not entirely unlike looking at the performance of a sports team such as a football or baseball team, within certain limits. Thus, the invention may be employed to use tools specific to the domain of the entity in which the data has contextual meaning. For a football league, one tool might look allow a look at total points per game while another might look at yardage gained, and these tools could be applied to single games, a number of successive games, games in weather above or below a certain temperature, etc. The tools would be arrayed along vectors in the same way as the securities analysis tools used in the examples. The term “entity” is used herein to generalize the data-generating object which is being analyzed, whether it be a stock, bond, hybrid security, athletic team, company, etc.

All of the functionality described herein, including the implementation of tools, should be understood as preferably achieved with one or more suitable computer programs executing on one or more computers (typically, the server computer), though computer programs have not been explicitly illustrated. Such computer programs typically are stored on any of a variety of media, indicated at 6A in FIG. 1, including, for example, read-only memory, random access memory, magnetic storage, optical storage, and so forth. Such media may be internal or external to the aforesaid computers, or partly internal and partly external. The client computer also may execute one or more or part of any such programs, or the client computer may act merely as an access device running a web browser.

Having thus described the inventive concepts and a number of exemplary embodiments, it will be apparent to those skilled in the art that the invention may be implemented in various ways, and that modifications and improvements will readily occur to such persons. For example, although a GUI according to the invention has been illustrated as a single graphical object (pyramid, cone, prism, cylinder, etc.), such a GUI may have multiple such objects, also. This may be done, for example, instead of adding sides or layers to an object already becoming complex, by adding an object. Another reason for using multiple graphical objects according to the invention is to allocate one object to a first stock and to allocate another object to a second stock, to facilitate their comparison. Thus, the examples given are not intended to be limiting. The invention is limited only as required by the following claims and equivalents thereto.

We claim:

1. A graphical user interface which presents to a user a hierarchical arrangement of at least one of company performance and security performance, and analytical tools for their evaluation.

2. The graphical user interface of claim 1 wherein an analytical tool may be selected for presenting an analysis of data in one of a number of predetermined, defined contexts.

3. The graphical user interface of claim 2 wherein the defined context is historical.

4. The graphical user interface of claim 2 wherein the defined context analyzes a company or security relative to others in its industry sector.

5. The graphical user interface of claim 2 wherein the defined context analyzes a company or security relative to one or more appropriate indices.

6. The graphical user interface of any of claims 1-5 wherein the interface is provided at a web site.

7. A method of facilitating the presentation of data regarding the performance of a company and a security issued by the company, comprising:
providing a web site having a page which, when addressed, provides a graphical user interface;
in the graphical user interface, arranging along a first vector a plurality of parameters to be evaluated and for each said parameter, arranging along a second vector a plurality of selectable analytical tools.

8. The method of claim 7 wherein the analytical tools arranged along said second vector are arranged in like order for each of the parameters.

9. The method of claim 7 or claim 8 further including receiving a user's selection of a company name or security symbol just once while allowing a user to navigate among said analytical tools.

10. The method of claim 9 wherein the tools are selectable by a user moving a cursor onto a cell representing a tool and then signaling selection of the tool.

11. The method of claim 10 or claim 15 wherein signaling includes clicking a mouse button.

12. A method of facilitating the presentation of data regarding the performance of a company and a security issued by the company, comprising:
providing a data source of quantitative information about the current and historical performance of the security;
providing a network of web sites, each having a page which, when addressed, provides a graphical user interface for invoking a predetermined tool for analyzing the security according to that tool; and
providing on the web sites pointers to selected other ones of the web sites such that the pointers have the effect of arranging the web sites along a first selection vector related to a plurality of parameters to be evaluated and further arranging the web sites such that for each said parameter pointers organize the sites along a second selection vector along which are arrayed a plurality of selectable analytical tools.

13. The method of claim 12 wherein the analytical tools arranged along said second vector are arranged in like order for each of the parameters.

14. The method of claim 12 or claim 13 further including receiving a user's selection of a company name or security symbol just once while allowing a user to select desired ones of said pointers to navigate among said analytical tools.

15. The method of claim 14 wherein each pointer corresponds to a tool and tools are selectable by a user moving a cursor onto a cell representing a tool itself or a pointer to the tool and then signaling selection of the tool.

16. A graphical user interface which presents to a user a hierarchical arrangement of past performance of an entity and analytical tools for studying the entity's performance from a plurality of perspectives.

17. A method of facilitating the presentation of data regarding the performance of an entity, comprising:
providing a data source of quantitative information about the current and historical performance of the entity;
providing a network of web sites, each having a page which, when addressed, provides a graphical user interface for invoking a predetermined tool for analyzing the entity according to that tool; and
providing on the web sites pointers to selected other ones of the web sites such that the pointers have the effect of arranging the web sites along a first selection vector related to a plurality of parameters to be evaluated and further arranging the web sites such that for each said parameter pointers organize the sites along a second selection vector along which are arrayed a plurality of selectable analytical tools.

18. The method of claim 17 wherein the analytical tools arranged along said second vector are arranged in like order for each of the parameters.

19. The method of claim 18 wherein each pointer corresponds to a tool and tools are selectable by a user moving a cursor onto a cell representing a tool itself or a pointer to the tool and then signaling selection of the tool.

20. A graphical user interface which presents to a user a hierarchical arrangement of domain-specific performance data, and analytical tools for their evaluation.

21. The graphical user interface of claim 20 wherein an analytical tool may be selected for presenting an analysis of data in one of a number of predetermined, defined contexts.

22. The graphical user interface of claim 21 wherein the defined context is historical.

23. The graphical user interface of any of claims 20-22 wherein the interface is provided at a web site.

24. A method of facilitating the presentation of data relating to the performance of an entity, comprising:
providing a web site having a page which, when addressed, provides a graphical user interface;
in the graphical user interface, arranging along a first vector a plurality of parameters to be evaluated relative to said entity data and for each said parameter, arranging along a second vector a plurality of selectable analytical tools for evaluating the data.

25. The method of claim 24 wherein the analytical tools arranged along said second vector are arranged in like order for each of the parameters.

26. The method of claim 24 or claim 25 further including receiving a user's selection of an entity identity just once while allowing a user to navigate among said analytical tools.

27. The method of claim 26 wherein the tools are selectable by a user moving a cursor onto a cell representing a tool and then signaling selection of the tool.

28. The method of claim 27 wherein signaling includes clicking a mouse button.

29. The method of claim 24 or claim 25 wherein said entity is a sports team.

30. A method of facilitating the presentation of data regarding the performance of an entity, comprising:
providing a data source of quantitative information about the current and historical performance of the entity;
providing a network of web sites, each having a page which, when addressed, provides a graphical user interface for invoking a predetermined tool for analyzing the entity according to that tool; and
providing on the web sites pointers to selected other ones of the web sites such that the pointers have the effect of arranging the web sites along a first selection vector related to a plurality of parameters to be evaluated and further arranging the web sites such that for each said parameter pointers organize the sites along a second selection vector along which are arrayed a plurality of selectable analytical tools.

31. The method of claim 30 wherein the analytical tools arranged along said second vector are arranged in like order for each of the parameters.

32. The method of claim 30 or claim 31 further including receiving a user's selection of an entity identification just once while allowing a user to select desired ones of said pointers to navigate among said analytical tools.

33. The method of claim 32 wherein each pointer corresponds to a tool and tools are selectable by a user moving a cursor onto a cell representing a tool itself or a pointer to the tool and then signaling selection of the tool.

34. A graphical user interface which presents to a user a hierarchical arrangement of past performance of an entity and analytical tools for studying the entity's performance from a plurality of perspectives.

35. A method of facilitating the presentation of data regarding the performance of an entity, comprising:
providing a data source of quantitative information about the current and historical performance of the entity;
providing a network of web sites, each having a page which, when addressed, provides a graphical user interface for invoking a predetermined tool for analyzing the entity according to that tool; and
providing on the web sites pointers to selected other ones of the web sites such that the pointers have the effect of arranging the web sites along a first selection vector related to a plurality of parameters to be evaluated and further arranging the web sites such that for each said parameter pointers organize the sites along a second selection vector along which are arrayed a plurality of selectable analytical tools.

36. The method of claim 35 wherein the analytical tools arranged along said second vector are arranged in like order for each of the parameters.

37. The method of claim 36 wherein each pointer corresponds to a tool and tools are selectable by a user moving a cursor onto a cell representing a tool itself or a pointer to the tool and then signaling selection of the tool.

38. A computer program product comprising a computer-readable medium having encoded therein instructions which when executed by a computer system provides a graphical user interface which presents to a user a hierarchical arrangement of at least one of company performance and security performance, and analytical tools for their evaluation.

39. The computer program product of claim 38 wherein an analytical tool may be selected for presenting an analysis of data in one of a number of predetermined, defined contexts.

40. A computer program product comprising a computer-readable medium having encoded therein instructions which when executed by a computer system provides a web site having a page which, when addressed, provides a graphical user interface in which there are arranged along a first vector a plurality of parameters to be evaluated and for each said parameter, there are arranged along a second vector a plurality of selectable analytical tools.

41. The computer program product of claim 40 wherein the analytical tools arranged along said second vector are arranged in like order for each of the parameters.

42. The computer program product of claim 40 wherein the parameters relate to a company or its security and the instructions allow a user's selection of a company name or security symbol to be input just once while allowing a user to navigate among said analytical tools.

43. A computer program product comprising a computer-readable medium having encoded therein instructions which when executed by a computer system provides
a network of web sites, each having a page which, when addressed, provides a graphical user interface for invoking a predetermined tool for analyzing a security according to that tool; and
on the web sites, pointers to selected other ones of the web sites, such that the pointers have the effect of arranging the web sites along a first selection vector related to a plurality of parameters to be evaluated and further arranging the web sites such that for each said parameter pointers organize the sites along a second selection vector along which are arrayed a plurality of selectable analytical tools.

44. The computer program product of claim 43 wherein the analytical tools arranged along said second vector are arranged in like order for each of the parameters.
